(19) United States
(12) Patent Application Publication
(10) Pub. No.: US 2014/0222642 A1
(43) Pub. Date: Aug. 7, 2014

(54) SYSTEM AND METHOD FOR PROPERTY SEARCHING AND TRADING

(71) Applicants: Marcel Emile Joseph Potvin, Victoria (CA); Terence Chenier, Mission (CA); Josef Lorne Faber, Vernon (CA)

(72) Inventors: Marcel Emile Joseph Potvin, Victoria (CA); Terence Chenier, Mission (CA); Josef Lorne Faber, Vernon (CA)

(73) Assignee: TRADEHOMES BY IREX INC., Vancouver (CA)

(21) Appl. No.: 14/173,737

(22) Filed: Feb. 5, 2014

Related U.S. Application Data
(60) Provisional application No. 61/760,785, filed on Feb. 5, 2013.

(51) Int. Cl. G06Q 50/16

(52) U.S. Cl. CPC G06Q 50/16; G06Q 40/04
USPC 705/37

(57) ABSTRACT

An Internet based system for identifying and initiating real estate trades in which potential direct and multi-party trades are identified and rated based on the quality of the match between desired features and on-offer features, and the rating is automatically conveyed to the users associated with the relevant properties.

### CROSS REFERENCE TO RELATED APPLICATIONS

This application claims the benefit of U.S. Provisional Patent Application No. 61/760,785, filed 5 Feb. 2013.

### FIELD OF THE INVENTION

The present invention relates to the field of transactions in real estate, and more particularly to internet-based systems for real estate transactions.

### BACKGROUND OF THE INVENTION

It is well known for a party wishing to sell real estate to post (either directly or with the assistance of a real estate agent) a listing describing the property. A party interested in purchasing property, and/or the prospective purchaser's real estate agent, reviews such listings to identify properties possibly suitable for purchase. In this way, online posting of property listings facilitates conventional party-to-party purchase-and-sale transactions in real estate.

Many real estate purchase-and-sale agreements are conditional, for example the purchaser's obligation to complete the purchase and sale is conditional on the purchaser's ability to sell the purchaser's existing property within a specified time period. Thus, the completion of many party-to-party purchase-and-sale agreements is subject to the completion of another essentially unrelated real estate transaction, and it is not uncommon for a real estate purchase-and-sale agreement to fail to close because the purchaser is unable to conclude a sale of the purchaser's existing property in a timely fashion.

If the real estate market is weak, the seller may find that the market value of the property would not provide the desired profit from the sale. In extreme cases, the selling price of a property may not even cover the encumbrances.

### SUMMARY OF THE INVENTION

In one aspect, the present invention provides an internet-implemented system for use by real estate agents in the matching of real estate sellers for identifying possible direct or multi-party trades.

In another aspect, the present invention provides a system for identifying and initiating real estate trades, the system including: a computer server accessible via the Internet; one or more databases connected to the computer server, and having saved therein, a plurality of client files with each client file having: a client offering, being features of real estate the client wishes to dispose of; a client wants, being features of real estate the client wishes to obtain; and an associated user; wherein the computer server is configured to: on a first client file being identified, search the other client files for want matches, being other client files in which the client offering has features satisfying high priority criteria of the client wants of the first client file, and ascribe a want match rating to each want match based on weightings assigned to the features of the client wants; search the want match for offer matches, being want matches in which the client offering of the first client file has features satisfying high priority criteria of the client wants of the want match, and ascribe an offer match rating to each offer match based on weightings assigned to the features of the client wants of the want match; and send via the Internet a notice to the one or more users associated with each of the first client file and any offer matches, of the want match rating and offer match rating.

The high priority criteria may be: size, location, type of home, number of bedrooms, number of bathrooms and price within +/−10% of desired price range.

On a percentage scale, the weightings of the features that are not high priority criteria may total no more than 20%; and the high priority criteria percentage may be 80% if the price is within the desired price range or 77% if the price is not within the desired price range but the price is within +/−10% of the desired price range, whereby if the price is not within the desired price range but the price is within +/−10% of the desired price range the maximum achievable match rating is 97%.

The weightings total of no more than 20% associated with the features that are not high priority criteria, may include a total of no more than 15% for medium priority criteria and a total of no more than 5% for low priority criteria. The medium priority criteria may include: basement type, nature of parking, school district and style of home; and the low priority criteria may include: heating type & source, cooling type, water type, sewer type, flooring, roofing, siding, lot size and acreage.

If the offer matches number less than a predetermined minimum number, the server may search for potential three-way trades, in that the server: searches the want matches for third-party want matches, being other client files in which the client offering has features satisfying high priority criteria of the want match, and ascribes a third-party want match rating to each third-party want match based on weightings assigned to the features of the client wants; searches the third-party want matches for third-party offer matches, being third-party want matches in which the client offering of the first client has features satisfying high priority criteria of the client wants of the third-party want match, and ascribes a third-party offer match rating to each offer match based on weightings assigned to the features of the client wants of the third-party want match; and sends via the Internet to the one or more users associated with each of the first client file, any offer matches and any third-party offer matches, the want match rating, the third-party offer match rating and the third-party want match rating.

If the offer matches and third-party offer matches number less than a predetermined minimum number, the server may search for potential four-way trades, in that the server: searches the third-party want matches for fourth-party want matches, being other client files in which the client offering has features satisfying high priority criteria of the third-party want match, and ascribes a fourth-party want match rating to each fourth-party want match based on weightings assigned to the features of the client wants; searches the fourth-party want matches for fourth-party offer matches, being fourth-party want matches in which the client offering of the first client has features satisfying high priority criteria of the client wants of the fourth-party want match, and ascribes a fourth-party offer match rating to each offer match based on weightings assigned to the features of the client wants of the fourth-party want match; and sends via the Internet to the one or more users associated with each of the first client file, any offer matches, any third-party offer matches and any fourth-party offer matches, the want match rating, the third-party want match rating, the fourth-party offer match rating and the fourth-party want match rating.

If the offer matches, third-party offer matches and fourth-party offer matches number less than a predetermined minimum number, the server may search for potential five-way trades, in that the server: searches the fourth-party want matches for fifth-party want matches, being other client files in which the client offering has features satisfying high priority criteria of the fourth-party want match, and ascribes a fifth-party want match rating to each fifth-party want match based on weightings assigned to the features of the client wants; searches the fifth-party want matches for fifth-party offer matches, being fifth-party want matches in which the client offering of the first client has features satisfying high priority criteria of the client wants of the fifth-party want match, and ascribes a fifth-party offer match rating to each offer match based on weightings assigned to the features of the client wants of the fifth-party want match; and sends via the Internet to the one or more users associated with each of the first client file, any offer matches, any third-party offer matches, any fourth-party offer matches and any fifth-party offer matches, the want match rating, the third-party want match rating, the fourth-party want match rating, the fifth-party offer match rating and the fifth-party want match rating.

### DETAILED DESCRIPTION WITH REFERENCE TO THE DRAWINGS

Embodiments of the present invention include an Internet-accessible computer-server-based system for identifying potential real estate trades, both two-party direct trades, and multi-party linked trades.

The system involves a website having functionality restricted to users having user accounts. Anyone can visit the site and “look around”, but in order to use the site, an account must be created. Users will generally be real estate agents.

When a potential user enters the site, they must sign up to gain full user access. They supply their email address and their personal information and they log-off. Shortly thereafter, they receive an authorization email from the server allowing them to log in to the site.

The initial log-in to the site directs the user to their personal information page. On this page, the user may upload their personal picture, company logo, address, (country, city, street address and postal/zip code) and additional contact information, such as telephone, cellular phone, email address, fax and website. Once completed, the user is directed to the payment section to pay for their subscription.

The website essentially provides software as a service and requires a subscription payment (e.g., monthly). No additional fees are required for any number of entries made to a user's account. Once the user account has been created, the user is directed to a personal home page where the user can now create or upload property listings.

To create a new property listing, the user is directed to a webpage, titled, “What My Client Has”. To create the new property listing, the user enters or uploads the following information for the user's client: first and last name(s), phone number, cellular phone number and email address. This information is only visible to the listing user. The user also enters or uploads the address of the property that the client has to sell, i.e.: Country, State or Province, street name and number, postal or zip code and neighbourhood, (if available). Note: Country, State/Province and city are required fields. This information is visible to all user account holders.

The user enters or uploads a description of the property the client has to sell. The information in this section is separated into three categories of importance: Level 1, Level 2 and level 3. Level 1 data is mandatory and must be provided to complete a listing. Level 2 and Level 3 are optional but recommended as they provide additional information about the listing.

Level 1 data is: location, number of bedrooms, number of bathrooms, type of basement, property type, garage and number of stories in dwelling. These headings all have drop-down menus with multiple possibilities under each heading. Additional information required in level 1 data is: year built, square footage, property tax and listing price.

Level 2 data supplies additional information about the property the client has to sell, being: Heating source, heating type, cooling type, view, water type, sewer type, type of flooring, type of roof and type of siding. These headings all have drop-down menus with multiple possibilities under each heading.

Level 3 data supplies further information about the subject property, being: lot size; acreage; local school district; interior features, being fireplace, ceiling fans, attic, intercom, jetted tub, security system, skylights, vaulted ceilings, other; kitchen features, being, fridge, stove, built-in oven, microwave, dishwasher, garburator and other; laundry features, which include washer, dryer, washer/dryer combination and other; and property features, being pool, acreage, work shop, deck, dock, greenhouse, hot tub/spa, sauna, pond, sprinkler system, water front and other.

The user may also enter or upload additional comments about the property.

The user now has three options: Back to my listings, Edit requirements or Submit Changes. If “Submit Changes” is selected and all mandatory fields have been completed, the program allows the user to proceed. If a mandatory field has been missed, the user will be directed to the missing field(s) which will be highlighted. Once all the system requirements have been met, the user is directed to the next page to upload pictures of the property.

The user may upload one or more photographs of the subject property (It is contemplated that a maximum of 50 photographs would be a reasonable upper limit for the total number of photographs to be uploaded per listing). A link to an online video showing the property (e.g., on YouTube™) and/or a virtual tour link may also be added.

Once the user has uploaded photographs and/or created the desired links to videos, or the user has elected to do neither of these, the user may proceed to “Client Wants”.

On the “Client Wants” page, the previously entered client information is automatically displayed along with a listing number which has automatically been assigned by the system. This information is only visible to the user creating the listing. The user enters or uploads a description of the type of property the user's client wishes to buy. The information in this section is separated into two categories of importance: Level 1 and Level 2.

Level 1 data is mandatory and must be provided. Level 2 is optional but recommended as Level 2 data provides useful additional information about the desired property.

Level 1 data is: Country, State or Province, City, number of bedrooms, number of bathrooms and property type. These items all have drop-down menus with multiple possibilities. Also required in level 1 data is the range of desired square footage and range of desired price. These two items have drop-down menus with various ranges.

Level 2 is: heating source, heating type, cooling type, view, water type, sewer type, type of flooring, type of roof, type of siding, garage type, number of stories, desired view, desired lot size and desired acreage. These headings all have drop-down menus with multiple possibilities under each heading. Additional level 2 data is: interior features, being fireplace, ceiling fans, attic, intercom, jetted tub, security system, skylights, vaulted ceilings, and other; kitchen features, being fridge, stove, built-in oven, microwave, dishwasher, garburator and other; laundry features, being washer, dryer, washer/dryer combination and other; property features, being pool, work shop, deck, dock, greenhouse, hot tub/spa, sauna, pond, sprinkler system, waterfront and other; and community features, which include community pool, gated community, golf course location, clubhouse, and other features.

Following entry or upload of the client wants data, the user is presented with three options: Back to my listings, Edit requirements or Submit Changes.

If “Submit Changes” is selected and all mandatory fields have been completed, the program allows user to proceed. If a mandatory field has been missed, the user is directed to the missing field(s) which are highlighted.

At any time, the user may return to the listing and do any editing such as adding or deleting information to increase or decrease the number of matches, add or delete photographs of the properties or change contact information.

Once completed, the listing is displayed on the user's personal home page. The completed listing displays the primary property picture, (if one has been uploaded), the client's name and the listing I.D. number. There are also buttons that allow the user to: preview the listing, de-activate the listing, list the status, edit the listing, edit the listing wants, edit listing images and perform a site search for matches.

Once the listing is completed and posted, it immediately becomes active in the system. The system begins identifying potential trades to accommodate properties having features that the client wants and the property that the client has to sell, both two-party direct trades, and multi-party linked trades.

The system is configured to assign match percentages to indicate the extent to which a property matches a prospective purchaser's indicated wants, based on weightings ascribed to property features.

The system first looks for matches for the user's client's wants in high priority fields, being size of the house (sq ft range), location (city, state/province, country), type of home, bedrooms, and bathrooms. If a property does not satisfy all five of these high priority wants, it is not further evaluated within this round of searching. If a property satisfies all five of these high priority wants, the listing price is compared to the want price range. If the listing price is within the want price range, the high-priority match percentage is set at 80%. If the listing price is within +/−10% of the want price range (referred to as a NEAR), then the high-priority match percentage is set at 77%. If the listing price is not within +/−10% of the want price range, then the property is not further evaluated within this round of searching.

If the high-priority match percentage for a property is 77% or greater, the system evaluates the matches in: medium priority fields, being basement type, parking (garage type), school district (if applicable) and style of home, assigning 3.75% to each medium priority field for which there is a match (for a potential total tally of 15% for the medium priority fields); and low priority fields, including heating type & source, cooling type, water type, sewer type, flooring, roofing, siding, lot size, and acreage, to each of which a percentage is assigned such that a match of all low priority fields would result in a total tally of 5%.

The total additional percentages potentially available through matching of the medium priority fields and the low priority fields is 20%. Thus, for a NEAR property (i.e., one for which the high-priority match percentage is 77%), the highest possible total want match percentage (i.e., the high-priority match percentage plus the medium-priority match percentage plus the low-priority match percentage) is 97%, whereas if the high-priority match percentage is 80%, the highest possible total want match percentage is 100%.

For each potential property for which a total want match percentage is generated, the system performs the same match percentage analysis as described above with respect to the wants indicated by the sellers of those potential properties and the listing information for the user's client's property. For each such potential property, unless the system determines that one of the high priority fields does not match or the price range is neither a match nor a NEAR, the system generates a total offer match percentage.

Potential properties for which the system generates both a total want match percentage and a total offer match percentage are direct trade candidates, meaning there is some potential for the user's client and the owner of the potential property to trade properties (referred to as a potential direct trade). If the match percentage analysis of the total want match percentage properties generates a number of potential direct trades that is at least a predetermined minimum number (e.g., 100), the system reports the potential direct trades to the user, with the potential direct trades ranked based first on the total want match percentage and if the total want match percentage of potential properties are the same, based on the total offer match percentage. If potential direct trades have both the same total want match percentage and the same total offer match percentage, then they are ranked in the order in which they were identified in the search

If the number of potential direct trades generated by the match percentage analysis of the total want match percentage properties, is not equal to or greater than the predetermined minimum number, then the system performs a want match percentage analysis of the wants associated with the properties for which a total want match percentage was previously generated but for which a total offer match percentage was not generated (i.e., potential properties thatwere not identified as direct trade candidates), to identify third party properties that potentially satisfy the wants of the owner of the property that potentially satisfy the wants of the user's client. The system then performs an offer match percentage analysis of the third party properties to identify any such third parties whose wants may be potentially satisfied by the user's client's property, thus indicating a potential three-way trade.

If the total number of potential direct trades and potential three-way trades is equal to or greater than the predetermined minimum number, then the system reports the potential direct trades and potential three-way trades to the user, with the potential direct trades grouped together and ranked as set out above, and the potential three-way trades grouped together and ranked based first on the total want match percentage of the user's client, then the total want match percentage of the seller of the property that potentially satisfies the user's client, and then the total want match percentage of the third party. If the various percentages are all the same for two or more potential three-way trades, they are ranked in the order in which they were identified by the system.

If the total number of potential direct trades and potential three-way trades is less than the predetermined minimum number, then the system performs the same analysis indicated above to identify potential four-way trades. If the total number of potential direct trades, potential three-way trades and potential four-way trades is equal to or greater than the predetermined minimum number, then the system reports the potential direct trades, potential three-way trades and potential four-way trades to the user, with the potential direct trades and potential three-way trades grouped together and ranked as set out above, and the potential four-way trades grouped together and ranked based first on the total want match percentage of the user's client, then the total want match percentage of the seller of the property that potentially satisfies the user's client, then the total want match percentage of the third party and then the total want match percentage of the fourth party. If the various percentages are all the same for two or more potential four-way trades, they are ranked in the order in which they were identified by the system.

If the total number of potential direct trades, potential three-way trades and potential four-way trades is less than the predetermined minimum number, then the system performs the same analysis indicated above to identify potential five-way trades. Then the system reports the potential direct trades, potential three-way trades, potential four-way trades and potential five-way trades to the user, with the potential direct trades, potential three-way trades and potential four-way trades grouped together and ranked as set out above, and the potential five-way trades grouped together and ranked based first on the total want match percentage of the user's client, then the total want match percentage of the seller of the property that potentially satisfies the user's client, then the total want match percentage of the third party, then the total want match percentage of the fourth party and then the total want match percentage of the fifth party. If the various percentages are all the same for two or more potential five-way trades, they are ranked in the order in which they were identified by the system.

Although the system could be configured to identify potential trades comprising more than five parties, it is understood that, given the complexities inherent in multi-party trades, trades involving more than five parties would generally be difficult to implement.

To be clear, a potential five-way trade would be identified when:
1. The user's client's “wants” sufficiently match property B's “haves”, however, user's client's “haves” do not sufficiently match property B's “wants”.
2. Property B's “wants” sufficiently match property C's “haves”, however, property C's “haves” do not sufficiently match property B's “wants”.
3. Property C's “wants” sufficiently match property D's “haves”, however, property D's “haves” do not sufficiently match property C's “wants”.
4. Property D's “wants” sufficiently match property E's “haves”, however, property E's “haves” do not sufficiently match property D's “wants”.
5. Property E's “wants” sufficiently match user's client's “haves”.

In the event that no matches are found at all, the user is notified and given the opportunity to either remove specific information or to modify the information to yield better results. By removing or modifying information that may be too specific the user may be able to see a broader range of listings to choose from that still have a generalized match to user's client's needs.

The user can view the details of each identified potential trade (direct or multi-party) for evaluation in terms of the user's client's needs. The contact for the other users associated with a potential trade is set out on with the details of each identified potential trade so as to enable the users to make direct contact with each other.

Other users associated with potential trades are automatically notified by the system that a new listing has been identified as a party to a potential trade for which the other user has a listing.

What is claimed is:

1. A system for identifying and initiating real estate trades, the system comprising:
a computer server accessible via the Internet;
one or more databases connected to the computer server, and having saved therein, a plurality of client files with each client file having:
a client offering, being features of real estate the client wishes to dispose of;
a client wants, being features of real estate the client wishes to obtain; and
an associated user;
wherein the computer server is configured to:
on a first client file being identified,
search the other client files for want matches, being other client files in which the client offering has features satisfying high priority criteria of the client wants of the first client file, and ascribe a want match rating to each want match based on weightings assigned to the features of the client wants;
search the want match for offer matches, being want matches in which the client offering of the first client file has features satisfying high priority criteria of the client wants of the want match, and ascribe an offer match rating to each offer match based on weightings assigned to the features of the client wants of the want match; and
send via the Internet a notice to the one or more users associated with each of the first client file and any offer matches, of the want match rating and offer match rating.

2. The system of claim 1, wherein the high priority criteria are: size, location, type of home, number of bedrooms, number of bathrooms and price within +/−10% of desired price range.

3. The system of claim 2, wherein, on a percentage scale, the weightings of the features that are not high priority criteria total no more than 20%; and the high priority criteria percentage is 80% if the price is within the desired price range or 77% if the price is not within the desired price range but the price is within +/−10% of the desired price range, whereby if the price is not within the desired price range but the price is within +/−10% of the desired price range the maximum achievable match rating is 97%.

4. The system of claim 3, wherein the weightings total of no more than 20% associated with the features that are not high priority criteria, comprises a total of no more than 15% for medium priority criteria and a total of no more than 5% for low priority criteria.

5. The system of claim 4, wherein:
the medium priority criteria comprise: basement type, nature of parking, school district and style of home; and
the low priority criteria comprise: heating type & source, cooling type, water type, sewer type, flooring, roofing, siding, lot size and acreage.

6. The system of claim 1, wherein, if the offer matches number less than a predetermined minimum number, the server searches for potential three-way trades, wherein, the server:
searches the want matches for third-party want matches, being other client files in which the client offering has features satisfying high priority criteria of the want match, and ascribes a third-party want match rating to each third-party want match based on weightings assigned to the features of the client wants;
searches the third-party want matches for third-party offer matches, being third-party want matches in which the client offering of the first client has features satisfying high priority criteria of the client wants of the third-party want match, and ascribes a third-party offer match rating to each offer match based on weightings assigned to the features of the client wants of the third-party want match; and
sends via the Internet to the one or more users associated with each of the first client file, any offer matches and any third-party offer matches, the want match rating, the third-party offer match rating and the third-party want match rating.

7. The system of claim 6, wherein if the offer matches and third-party offer matches number less than a predetermined minimum number, the server searches for potential four-way trades, wherein the server:
searches the third-party want matches for fourth-party want matches, being other client files in which the client offering has features satisfying high priority criteria of the third-party want match, and ascribes a fourth-party want match rating to each fourth-party want match based on weightings assigned to the features of the client wants;
searches the fourth-party want matches for fourth-party offer matches, being fourth-party want matches in which the client offering of the first client has features satisfying high priority criteria of the client wants of the fourth-party want match, and ascribes a fourth-party offer match rating to each offer match based on weightings assigned to the features of the client wants of the fourth-party want match; and
sends via the Internet to the one or more users associated with each of the first client file, any offer matches, any third-party offer matches and any fourth-party offer matches, the want match rating, the third-party want match rating, the fourth-party offer match rating and the fourth-party want match rating.

8. The system of claim 7, wherein if the offer matches, third-party offer matches and fourth-party offer matches number less than a predetermined minimum number, the server searches for potential five-way trades, wherein the server:
searches the fourth-party want matches for fifth-party want matches, being other client files in which the client offering has features satisfying high priority criteria of the fourth-party want match, and ascribes a fifth-party want match rating to each fifth-party want match based on weightings assigned to the features of the client wants;
searches the fifth-party want matches for fifth-party offer matches, being fifth-party want matches in which the client offering of the first client has features satisfying high priority criteria of the client wants of the fifth-party want match, and ascribes a fifth-party offer match rating to each offer match based on weightings assigned to the features of the client wants of the fifth-party want match; and
sends via the Internet to the one or more users associated with each of the first client file, any offer matches, any third-party offer matches, any fourth-party offer matches and any fifth-party offer matches, the want match rating, the third-party want match rating, the fourth-party want match rating, the fifth-party offer match rating and the fifth-party want match rating.
